(19) United States
(12) Patent Application Publication
(10) Pub. No.: US 2005/0153224 A1
(43) Pub. Date: Jul. 14, 2005

(54) Toner for electrophotographic imaging apparatus

(75) Inventors: Duck-hee Lee, Seoul (KR); Jong-moon Eun, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/028,041

(22) Filed: Jan. 4, 2005

(30) Foreign Application Priority Data
Jan. 9, 2004 (KR) 2004-1417

(51) Int. Cl. G03G 9/08

(52) U.S. Cl. 430/108.6; 430/108.2; 430/108.1

(57) ABSTRACT

A toner of an electrophotographic imaging apparatus includes a binder resin, a coloring agent, a mold release agent, a charge control agent, and external additives, and is characterized in that the external additives include silica particles having a polarity counter to a polarity of the toner, silica particles having a same polarity as the polarity of the toner, titanium oxide particles having a same polarity as the polarity of the toner, and strontium titanate particles having a same polarity as the polarity of the toner. A uniform image density may be obtained even though the number of printed pages is increased, as well as at the beginning of printing, and particularly, poor image development such as fog, etc. can be prevented by use of the above toner for an electrophotographic imaging apparatus.

### CROSS-REFERENCE TO RELATED APPLICATIONS

This application claims the priority of Korean Patent Application No. 2004-1417, filed on Jan. 9, 2004, in the Korean Intellectual Property Office, the disclosure of which is incorporated herein in its entirety by reference.

### BACKGROUND OF THE INVENTION

1. Field of the Invention

The present invention relates to a toner of an electrophotographic imaging apparatus, and more particularly, to a toner of an electrophotographic imaging apparatus by which a uniform image density may be obtained over a lifetime, and particularly, poor image development such as fog, and the like, may be prevented.

2. Description of the Related Art

FIG. 1 schematically illustrates an example of a conventional, non-contact developing-type electrophotographic imaging apparatus having an operating mechanism as follows. A photoreceptor 1 is charged by a charging apparatus 6, and then a latent image is formed on the photoreceptor by exposing an image to light through a laser-scanning unit (LSU) 9. A toner 4 is fed to a developing roller 2 by a feeding roller 3. The toner 4 fed to the developing roller 2 is thin-layered with a uniform thickness by a toner layer-control apparatus 5 while being charged by high friction. The toner 4, after being passed through the toner layer-control apparatus 5, is developed on the electrostatic latent image formed on the photoreceptor 1, and the developed toner is transferred to paper by a transferring roller (not shown), and then fused by a fusing apparatus (not shown). After being transferred to the photoreceptor 1, the remaining toner 8 is cleaned by a cleaning blade 7.

A toner of an electrophotographic imaging apparatus requires many physical, chemical and thermal properties, and particularly, the charging and mobility properties of a toner are significant important factors with respect to the quality of a printed image. Further, a toner for an electrophotographic imaging apparatus must be prepared such that the toner may have a stable charge and increased developing efficiency, and a non-fogging property even, with changes over time due to long periods of image printing, as well as environmental changes.

Now, to achieve stabilizing the amount of charging of toner, anti-fogging, enhancing a developing efficiency, and the like, the methods of adding external additives, such as a charge control agent, a silica, a titanium dioxide (TiO₂), or the like, to a toner have been tried. However, these methods have limitations in improving an image quality as well.

However, despite adding such external additives, for conventional toners, excessive charging may occur at low temperatures and humidity levels, a fog may contaminate a non-image part, and toner scattering may occur due to a decrease in charge at high temperatures and humidity levels, thus increasing a variability in the charging property of a toner due to an environmental change. Furthermore, in the initial stage of printing, the toner has uniform charges and charge distribution. However, in time, the amount of charging is greatly decreased, and a decrease in image density and fogging and toner scattering occur due to a decrease in charges and a generation of a non-uniform charge distribution over long periods.

To solve the above-cited problems and impart a uniform charging property to a toner, it is necessary to form a thin toner layer on a developing roller. However, when the toner layer is too thin, a developing efficiency is drastically decreased due to a surge in the amount of charging of the toner and the toner deterioration by toner stress, thus decreasing the image density. When the amount of charging of the toner is decreased to improve such developing efficiency, a contamination due to an increase of the amount of fog and toner scattering may occur.

### SUMMARY OF THE INVENTION

The present invention provides a toner of an electrophotographic imaging apparatus by which a uniform image density may be obtained over a lifetime, and poor image development such as fog, and the like, may be prevented.

According to an aspect of the present invention, a toner of an electrophotographic imaging apparatus comprises a binder resin, a coloring agent, a mold release agent, a charge control agent, and external additives, characterized in that the external additives comprise silica particles having a polarity counter to the polarity of the toner, silica particles having the same polarity as the polarity of the toner, titanium oxide particles having the same polarity as the polarity of the toner, and strontium titanate particles having the same polarity as the polarity of the toner.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawing of which:

FIG. 1 is a schematic drawing showing a conventional electrophotographic imaging apparatus.

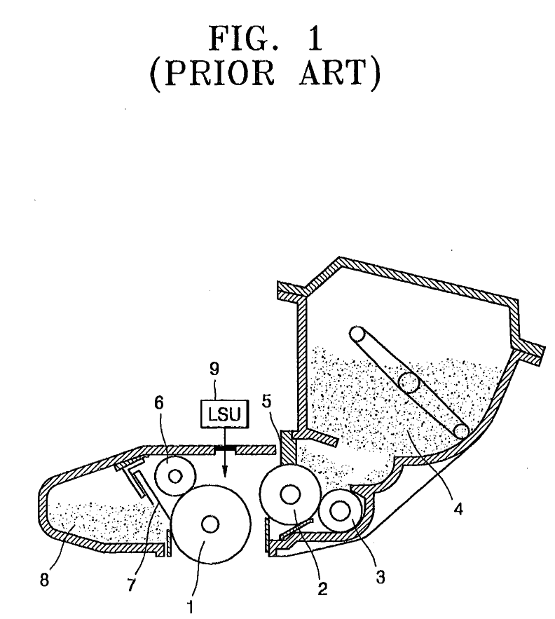

### DETAILED DESCRIPTION OF THE EMBODIMENTS

Reference will now be made in detail to the embodiments of the present invention.

A toner particle according to an embodiment of the present invention comprises a binder resin, a coloring agent, a mold release agent, a charge control agent and external additives.

A binder resin that may be used in an embodiment of the present invention includes, but is not limited to, a styrene-butadiene copolymer, a styrene-acrylonitrile copolymer, a modified acrylic polymer, a polyvinyl acetate, styrene-alkyd resins, soya-alkyl resins, a polyvinylchloride, a polyvinylidene chloride, a polyacrylonitrile, polycarbonates, a polyacrylic acid, polyacrylates, polymethacrylates, styrene polymers, a polyvinyl butyral, alkyd resins, polyamides, polyurethanes, polyesters, polysulfones, polyethers, polyketones, phenoxy resins, epoxy resins, silicon resins, polysiloxanes, poly(hydroxyether) resins, polyhydroxystyrene resins, a novolak, phenylglycidylether-dicyclopentadiene copolymer, and copolymers of monomers used in the above polymers and a combination thereof. Of these, the polyester resin is suitable for use as a color developing agent due to its superior fusing property and transparency.

For a black and white toner, carbon black or aniline black may be used as a coloring agent, and may readily be used to prepare a non-magnetic color toner according to an embodiment of the present invention. Also, for a color toner, carbon black or aniline black is used as a black color of a coloring agent, and yellow, magenta and cyan coloring agents are also utilized.

The yellow coloring agent may be a condensed nitrogen compound, an isoindolinone compound, an anthraquine compound, an azo metal complex or an allyl imide compound. Specifically, C.I. PIGMENT YELLOW12, 13, 14, 17, 62, 74, 83, 93, 94, 95, 109, 110, 111, 128, 129, 147 or 168, or the like, may be used.

The magenta coloring agent may be a condensed nitrogen compound, an anthraquine compound, a quinacridone compound, a naphthol compound, a benzoimidazole compound, a thioindigo compound or a perylene compound. Specifically, C.I. PIGMENT RED 2, 3, 5, 6, 7, 23, 48:2, 48:3, 48:4, 57:1, 81:1, 144, 146, 166, 169, 177, 184, 185, 202, 206, 220, 221 or 254, or the like, may be used.

The cyan coloring agent may be a copper phthalocyanine compound and its derivatives, or an anthraquine compound. Specifically, C. I. PIGMENT BLUE 1, 7, 15, 15:1, 15:2, 15:3, 15:4, 60, 62 or 66, or the like, may be used.

The coloring agent may be used alone or in a mixture of at least two types of coloring agents, and may be selected base on color, saturation, brightness, weatherability, dispersity in toners, or the like.

The amount of the coloring agent may be an amount sufficient to color the toner and to form a visible image by development, and may be 2 to 20 parts by weight based on 100 parts by weight of a binder resin. If less than 2 parts by weight of the coloring agent is used, coloring effects are insufficient. If the amount of the coloring agent exceeds 20 parts by weight, the electrical resistance is decreased, and thus, a sufficient amount of frictional charge cannot be obtained. Therefore, the possibility of contamination arises.

The charge control agent may be a negatively chargeable charge control agent or a positively chargeable charge control agent. The negatively chargeable charge control agent may be, but is not limited to, an organic metal complex, such as chromium-containing azo dyes or monoazo metal complex, or a chelate compound; a salicylic acid compound containing metals such as chromium, iron, aluminum and zinc; or an organic metal complex of aromatic hydroxycarboxylic acid and aromatic dicarboxylic acid. The positively-chargeable charge control agent may be, but is not limited to, a product modified with nigrosine and its fatty acid metal salt, or the like; a triphenylmethane derivatives; or an onium salt comprising a quaternary ammonium salt, such as tributylbenzylammonium 1-hydroxy-4-naphthosulfonate, tetrabutylammonium tetrafluoroborate, stearyldimethylbenzylammonium paratoluenesulfonate, stearyldimethylbenzylammonium methylsulfate, stearyldimethylphenethylammonium methylsulfate, distearyidimethylammonium chloride, desyltrimethylammonium hydroxide, or the like. The positively chargeable charge control agent may be composed of one or a combination of at least two of these salts.

The mold release agent used in an embodiment of the present invention may be, but is not limited to, a polyalkylene wax such as low molecular weight polypropylene, low molecular weight polyethylene, or the like, an ester wax, a carnauba wax, a paraffin wax, a higher fatty acid, a fatty acid amide, or the like. Specific examples thereof include a fluorinated polymer, a siloxane polymer, a fluorosilicon polymer, a polysilane, a polyethylene, a polypropylene, a polyacrylate, a poly(methyl methacrylate-co-methacrylic acid), urethane resins, urethane-epoxy resins, an acrylated urethane resin, urethane-acryl based resins, or combinations thereof.

The external additives according to an embodiment of the present invention comprises silica particles having a polarity counter to the polarity of the toner, silica particles having the same polarity as the polarity of the toner, titanium oxide particles having the same polarity as the polarity of the toner, and strontium titanate particles having the same polarity as the polarity of the toner.

A toner according to the present invention comprises such particles, thus decreasing an effect by an environmental change or time, maintaining continuously and stably uniform charges, and obtaining a uniform distribution of the amount of charging by suppressing the generation of a toner having a counter polarity.

The silica particles having a polarity counter to the polarity of the toner may have a particle diameter of 30 to 200 nm. When the particle diameter of the silica particles is less than 30 nm, non-uniformity of toner charges may arise. When the particle diameter of the silica particles exceeds 200 nm, the particles are readily removed from the toner.

The silica particles having the same polarity as the polarity of the toner may have a particle diameter of 5 to 200 nm, generally 10 to 100 nm. When the average particle diameters of the silica particles are less than 5 nm, poor fusing and offset properties and deterioration of a toner charge performance may arise. When the particle diameters of the silica particles exceed 200 nm, a decrease in toner mobility may occur.

The amount of the silica particles having a polarity counter to the polarity of the toner may be 0.1 to 3.0% by weight based on the total weights of the toner. When the amount is less than 0. 1% by weight, a decrease of contamination at a non-imaging part cannot be accomplished. When the amount exceeds 3.0% by weight, an increase of non-uniformity in toner charges and the amount of fog generated, or the like, may occur.

The amount of the silica particles having the same polarity as the polarity of the toner may be 0.1 to 6.0% by weight based on the total weights of the toner. When the amount is less than 0.1% by weight, a decrease in the toner mobility and charging property may occur. When the amount exceeds 6.0% by weight, a poor fusing property and a contamination of the image may occur.

The silica particles having the same polarity as the polarity of the toner may comprise 0.1 to 3.0% by weight of a first silica having an average particle diameter of 30 to 200 nm, and 0.1 to 3.0% by weight of a second silica having an average particle diameter of 5 to 20 nm based on the total weights of the toner.

When using the two types of silica having different particle diameters, the major role of the first silica is preventing deterioration of the toners due to internal pores by acting as a spacer particle and enhancing transferability, and the role of the second silica is largely to impart mobility to the toners.

When mixing the silica particles having a polarity counter to the polarity of the toner with the silica particles having the same polarity as the polarity of the toner, comprising the first silica particles and the second silica particles, a ratio of the weights of the particles having an average particle diameter of less than 30 nm, i.e., the second silica particles of the silica particles having the same polarity as the polarity of the toner, to particles having an average particle diameter of more than 30 nm, i.e., the sum of the silica particles having a polarity counter to the polarity of the toner, and the first silica particles of the silica particles having the same polarity as that of the toner may be less than 4, and generally, less than 3. When the weight ratio exceeds 4, a decrease in the properties of the toner charging, poor transferability and a fusing property may occur.

External additives used in a toner according to an embodiment of the present invention comprise titanium oxide particles having the same polarity as the polarity of the toner and strontium titanate particles having the same polarity as the polarity of the toner, in addition to the silica particles having a polarity counter to the polarity of the toner and the silica particles having the same polarity as the polarity of the toner. The titanium oxide particles are added to improve a developing property and to stabilize the charging property, and the strontium titanate particles are added to provide an anti-fogging characteristic.

Titanium oxide particles having the same polarity as the polarity of the toner may have an average particle diameter of 0.01 to 1 μm. When the average particle diameter of the titanium oxide particle is less than 0.01 μm, a contamination of an image may occur at low temperatures and levels of humidity. When the average particle diameter of the titanium oxide particles exceeds 1 μm, the particles are easily removed from the toner.

Strontium titanate particles having the same polarity as the polarity of the toner may have an average particle diameter of 0.05 to 1 μm. When the average particle diameter of the strontium titanate particles is less than 0.05 μm, the problem of non-uniformity in charging may be increased. When the average particle diameter of the titanium oxide particles exceeds 1 μm, the particles are readily removed from the toner.

The amount of the titanium oxide particles having the same polarity as the polarity of the toner may be 0.1 to 2.0% by weight based on the total weights of the toner. When the amount is less than 0.1% by weight, a decrease in a developing property may occur. When the amount exceeds 2.0% by weight, a decrease in charging performance and fogging may occur.

The amount of the strontium titanate particles having the same polarity as the polarity of the toner may be 0.1 to 2.0% by weight based on the total weights of the toner. When the amount is less than 0.1% by weight, no significant improvement in anti-fogging may be achieved. When the amount exceeds 2.0% by weight, poor development and a contamination in a development member may occur.

The toner according to an embodiment of the present invention may also be prepared by a polymerization method or a melt-kneading pulverization method. To attach the external additives to toner particles, the toner particles and the external additives are combined in a desired ratio, and the mixture is placed in an agitator, such as a HENSCHEL MIXER, and stirred such that the external additives may attach to the surface of the toner particles by mixing, or both particles are mixed in a surface modifier, such as a ‘NARA HYBRIDIZER,’ and stirred such that the external additives may attach to the toner particles by embedding at least part of the external additive particles on the surface of the toner particles.

The present invention will be described in greater detail with reference to the following examples. The following examples are for illustrative purposes only and are not intended to limit the scope of the invention.

### EXAMPLES

A toner according to an embodiment of the present invention (negatively chargeable toner) was prepared by a pulverization method according to the following Examples 1 and 2.

### Example 1

A toner comprising the following components was prepared:

| | |
|---|---|
| A polyester | 90.5% by weight |
| Carbon black | 5% by weight |
| A negatively chargeable charge | 2.5% by weight |
| control agent (Hodogaya, Fe complex) | |
| A low molecular weight polypropylene wax | 2% by weight |

The components above were mixed uniformly using a HENSCHEL-type mixer. Then, the mixture was infused to a biaxial extruder and a melted mixture was extruded at 130° C. The extrudate was cooled and coagulated, and then an untreated toner with an average particle diameter of about 8 μm was obtained using a grinding classifier, and the following external additives were added externally to obtain a toner according to an embodiment of the present invention:

Positively chargeable silica particles (the first particle diameter is 30 to 50 nm)=0.5% by weight

Negatively chargeable silica particles (the first particle diameter is 7 to 16 nm)=1.5% by weight

Negatively chargeable titanium oxide particles (the first particle diameter is 50 to 150 nm)=0.5% by weight

Negatively chargeable strontium titanate particles (the first particle diameter is 50 to 150 nm)=0.5% by weight

### Example 2

A toner was prepared according to the same manner as in Example 1, except that external additives comprising the following components were added externally to untreated toner particles:

Positively chargeable silica particles (the first particle diameter is 30 to 50 nm)=0.5% by weight

Negatively chargeable silica particles (the first particle diameter is 30 to 50 nm)=0.5 % by weight

Negatively chargeable silica particles (the first particle diameter is 7 to 16 nm)=1.5 % by weight

Negatively chargeable titanium oxide particles (the first particle diameter is 50 to 150 nm)=0.5 % by weight

Negatively chargeable strontium titanate particles (the first particle diameter is 50 to 150 nm)=0.5 % by weight

### COMPARATIVE EXAMPLES

A conventional toner (negatively chargeable toner) was prepared by a pulverizing method according to the following comparative examples 1 to 3.

### Comparative Example 1

A toner was prepared according to the same manner as in Example 1, except that external additives comprising the following components were added externally to untreated toner particles:

Positively chargeable silica particles (the first particle diameter is 30 to 50 nm)=0.5% by weight

Negatively chargeable silica particles (the first particle diameter is 7 to 16 nm)=1.5% by weight

Negatively chargeable titanium oxide particulates (the first particle diameter is 50 to 150 nm)=0.5% by weight

### Comparative Example 2

A toner was prepared according to the same manner as in Example 1, except that external additives comprising the following components were added externally to untreated toner particles:

Positively chargeable silica particles (the first particle diameter is 30 to 50 nm)=0.5% by weight

Negatively chargeable silica particles (the first particle diameter is 7 to 16 nm)=1.5% by weight

Negatively chargeable strontium titanate particles (the first particle diameter is 50 to 150 nm)=0.5% by weight

### Comparative Example 3

A toner was prepared according to the same manner as in Example 1, except that external additives comprising the following components were added externally to untreated toner particles:

Negatively chargeable silica particles (the first particle diameter is 30 to 50nm)=0.5% by weight

Negatively chargeable silica particles (the first particle diameter is 7 to 16nm)=1.5% by weight

Negatively chargeable titanium oxide particles (the first particle diameter is 50 to 150nm)=0.5% by weight

Negatively chargeable strontium titanate particles (the first particle diameter is 50 to 150 nm)=0.5% by weight

### TEST EXAMPLE

### Image Evaluation Test

Images produced with the toner of Examples 1 and 2, and Comparative examples 1 to 3 were evaluated using the following condition and method.

Condition for image evaluation test

Surface electric potential (V₀): −700 V

Latent image electric potential (V_{L}): −100 V

Applied voltage of developing roller:
Vₚ₋ₚ=1.8 kV, frequency=2.0 kHz,
V_{dc}=−500V, Duty ratio=35% (spherical wave)

Developing gap (GAP): 150˜400 μm

Developing roller:

(1) For aluminum

Roughness: Rz=1˜2.5 (after doping with nickel)

(2) For rubber roller (NBR-based elastic rubber roller)
resistance: 1×10⁵18 5×10⁶ Ω
hardness: 50

Toner: charged quantity (q/m)=—5 to —30μ C/g

(on developing roller after passage of layer control apparatus)
toner per area=0.3 to 1.0 mg/cm²

Image evaluation test method

Images produced with the toner of Examples 1 and 2, and Comparative examples 1 to 3 were evaluated using a 20 ppm-grade laser printer. A test of printing 8,000 pages was performed using the condition for image evaluation test described above at an ambient temperature and level of humidity. Then, the image density, fog (a contamination in a non-image area), and dot reproducibility were measured per 2,000 pages, and the results were compared.

The image density was measured by determining the density of a black solid pattern on paper using the SPECTROEYE densitometer (manufactured by the GRETAG MACBETH CO.), and the fog density was measured by taping a fog on a latent image carrier with an acetate adhesive tape (manufactured by the 3M COMPANY) when printing a blank paper, and then measuring the taping density using the SPECTROEYE densitometer (manufactured by the GRETAG MACBETH CO.). The dot reproducibility was evaluated with the naked eye.

The image density, the fog density and the dot reproducibility, per printed page, for the toner of Examples 1 and 2, and Comparative examples 1 to 3 are shown in Tables 1 to 3.

TABLE 1
image density

| | Printed pages | | | | |
|---|---|---|---|---|---|
| | 0 | 2,000 | 4,000 | 6,000 | 8,000 |
| Example 1 | ◯ | ◯ | ◯ | ◯ | Δ |
| Example 2 | ◯ | ◯ | ◯ | ◯ | Δ |
| Comparative | ◯ | ◯ | ◯ | ◯ | Δ |
| example 1 | | | | | |
| Comparative | ◯ | ◯ | Δ | Δ | X |
| example 2 | | | | | |
| Comparative | ◯ | ◯ | ◯ | Δ | Δ |
| example 3 | | | | | |

X: <1.1
Δ: 1.1˜1.3
◯: >1.3

TABLE 2
fog density

| | Printed pages | | | | |
|---|---|---|---|---|---|
| | 0 | 2,000 | 4,000 | 6,000 | 8,000 |
| Example 1 | ◯ | ◯ | ◯ | ◯ | Δ |
| Example 2 | ◯ | ◯ | ◯ | ◯ | ◯ |
| Comparative | ◯ | ◯ | Δ | X | X |
| example 1 | | | | | |
| Comparative | ◯ | ◯ | ◯ | ◯ | Δ |
| example 2 | | | | | |
| Comparative | ◯ | ◯ | Δ | Δ | X |
| example 3 | | | | | |

X: >0.16
Δ: 0.15˜0.16
◯: <0.15

TABLE 3
dot reproducibility

| | Printed pages | | | | |
|---|---|---|---|---|---|
| | 0 | 2,000 | 4,000 | 6,000 | 8,000 |
| Example 1 | ◯ | ◯ | ◯ | ◯ | ◯ |
| Example 2 | ◯ | ◯ | ◯ | ◯ | ◯ |
| Comparative | ◯ | ◯ | ◯ | ◯ | Δ |
| example 1 | | | | | |
| Comparative | ◯ | Δ | Δ | X | X |
| example 2 | | | | | |
| Comparative | ◯ | ◯ | ◯ | ◯ | Δ |
| example 3 | | | | | |

◯: when a problem is not recognized by the naked eye
Δ: when a problem is recognized by the naked eye
X: when a problem is recognized seriously by the naked eye.

As may be seen from the results of the Tables 1 to 3, for a toner according to Comparative example 1, a fogging problem was serious when the number of printed pages exceeded 6,000; for a toner according to Comparative example 2, a problem in image density and dot reproducibility was significant when the number of printed pages exceeded 6,000; and for a toner according to Comparative example 3, a problem in image density and fogging occurred when the number of printed pages exceeded 6,000.

Meanwhile, a toner according to an embodiment of the present invention exhibited improved levels in image density, fog density and dot reproducibility constantly from the beginning of printing to the end of printing.

As described above, by using a toner for an electrophotographic imaging apparatus, a uniform image density may be obtained even though the number of printed pages is increased, as well as at the beginning of printing, and particularly, poor image development, such as fog, and the like, may be prevented.

Thus, the present invention includes a reproduction material of an electrophotographic imaging apparatus that comprises a toner having external additives comprising silica particles having a polarity counter to a polarity of the toner, silica particles having a same polarity as the polarity of the toner, titanium oxide particles having a same polarity as the polarity of the toner, and strontium titanate particles having a same polarity as the polarity of the toner.

Although a few embodiments of the present invention have been shown and described, it would be appreciated by those skilled in the art that changes may be made in these embodiments without departing from the principles and spirit of the invention, the scope of which is defined in the claims and their equivalents.

1. A toner of an electrophotographic imaging apparatus, comprising:
a binder resin;
a coloring agent;
a mold release agent;
a charge control agent; and
external additives comprising silica particles having a polarity counter to a polarity of the toner, silica particles having a same polarity as the polarity of the toner, titanium oxide particles having a same polarity as the polarity of the toner, and strontium titanate particles having a same polarity as the polarity of the toner.

2. The toner of the electrophotographic imaging apparatus of claim 1, wherein the silica particles having a polarity counter to the polarity of the toner have an average particle diameter of 30 to 200 nm, and the amount of the particles is 0.1 to 3.0% by weight based on the total weights of the toner.

3. The toner of the electrophotographic imaging apparatus of claim 1, wherein the silica particles having the same polarity as the polarity of the toner have an average particle diameter of 5 to 200 nm, and the amount of the particles is 0.1 to 6.0% by weight based on the total weights of the toner.

4. The toner of the electrophotographic imaging apparatus of claim 1, wherein the titanium oxide particles having the same polarity as the polarity of the toner have an average particle diameter of 0.01 to 1 μm, and the amount of the particles is 0.1 to 2.0% by weight based on the total weights of the toner.

5. The toner of the electrophotographic imaging apparatus of claim 1, wherein the strontium titanate particles having the same polarity as the polarity of the toner have an average particle diameter of 0.05 to 1 μm, and the amount of the particles is 0.1 to 2.0% by weight based on the total weights of the toner.

6. The toner of the electrophotographic imaging apparatus of claim 1, wherein the silica particles having the same polarity as the polarity of the toner have an average particle diameter of 10 to 100 nm.

7. The toner of the electrophotographic imaging apparatus of claim 1, wherein the silica particles having the same polarity as the polarity of the toner comprises 0.1 to 3.0% by weight, of a first silica having an average particle diameter of 30 to 200 nm, and 0.1 to 3.0% by weight of a second silica having an average particle diameter of 5 to 20 nm based on the total weights of the toner.

8. The toner of the electrophotographic imaging apparatus of claim 7, wherein a weight ratio of the second silica particulates of the silica particles having the same polarity as the polarity of the toner to the sum of the silica particles having a polarity counter to the polarity of the toner and the first silica particles of the silica particles having the same polarity as the polarity of the toner is less than 4.

9. The toner of the electrophotographic imaging apparatus of claim 7, wherein a weight ratio of the second silica particulates of the silica particles having the same polarity as the polarity of the toner to the sum of the silica particles having a polarity counter to the polarity of the toner and the first silica particles of the silica particles having the same polarity as the polarity of the toner is less than 3.

10. The toner of the electrophotographic imaging apparatus of claim 3, wherein the silica particles having the same polarity as the polarity of the toner have an average particle diameter of 10 to 100 nm.

11. The toner of the electrophotographic imaging apparatus of claim 3, wherein the silica particles having the same polarity as the polarity of the toner comprises 0.1 to 3.0% by weight, of a first silica having an average particle diameter of 30 to 200 nm, and 0.1 to 3.0% by weight of a second silica having an average particle diameter of 5 to 20 nm based on the total weights of the toner.

12. The toner of the electrophotographic imaging apparatus of claim 1, wherein the binder resin includes at least one of: a styrene-butadiene copolymer, a styrene-acrylonitrile copolymer, a modified acrylic polymer, a polyvinyl acetate, a styrene-alkyd resin, a soya-alkyl resin, a polyvinylchloride, a polyvinylidene chloride, a polyacrylonitrile, a polycarbonate, a polyacrylic acid, a polyacrylate, a polymethacrylate, a styrene polymer, a polyvinyl butyral, an alkyd resin, a polyamide, a polyurethane, a polyester, a polysulfone, a polyether, a polyketone, a phenoxy resin, an epoxy resin, a silicon resin, a polysiloxane, a poly(hydroxyether) resin, a polyhydroxystyrene resin, a novolak, a phenylglycidylether-dicyclopentadiene copolymer, and copolymers of monomers used in the above polymers and a combination thereof.

13. The toner of the electrophotographic imaging apparatus of claim 1, wherein, for a black and white toner, carbon black or aniline black is used as a coloring agent.

14. The toner of the electrophotographic imaging apparatus of claim 1, wherein the coloring agent is used alone or in a mixture of at least two types of coloring agents.

15. The toner of the electrophotographic imaging apparatus of claim 1, wherein an amount of the coloring agent comprises from approximately 2 to 20 parts by weight based on 100 parts by weight of a binder resin.

16. The toner of the electrophotographic imaging apparatus of claim 1, wherein the charge control agent is a negatively chargeable charge control agent or a positively chargeable charge control agent.

17. The toner of the electrophotographic imaging apparatus of claim 16, wherein the negatively chargeable charge control agent is one of an organic metal complex; a salicylic acid compound containing a metal; or an organic metal complex of aromatic hydroxycarboxylic acid and aromatic dicarboxylic acid.

18. The toner of the electrophotographic imaging apparatus of claim 16, wherein the positively-chargeable charge control agent is a product modified with nigrosine and its fatty acid metal salt; a triphenylmethane derivatives; or an onium salt comprising a quaternary ammonium salt, or a combination of thereof.

19. The toner of the electrophotographic imaging apparatus of claim 1, wherein the mold release agent is a polyalkylene wax, an ester wax, a carnauba wax, a paraffin wax, a higher fatty acid, a fatty acid amide or a combination thereof.

20. A reproduction material of an electrophotographic imaging apparatus, comprising:
a toner having external additives comprising silica particles having a polarity counter to a polarity of the toner, silica particles having a same polarity as the polarity of the toner, titanium oxide particles having a same polarity as the polarity of the toner, and strontium titanate particles having a same polarity as the polarity of the toner.
